(19) United States
(12) Patent Application Publication
(10) Pub. No.: US 2026/0225957 A1
(43) Pub. Date: Aug. 6, 2026

(54) SYNTHESIS OF CEMENT FROM ALTERNATIVE RAW MATERIALS AND FUELS THAT REDUCES OR ELIMINATES CO2 EMISSIONS

(71) Applicant: Batuga Tech LLC, Princeton, NJ (US)

(72) Inventor: Vahit Atakan, Princeton, NJ (US)

(21) Appl. No.: 19/150,845

(22) PCT Filed: Jan. 24, 2024
(86) PCT No.: PCT/US2024/012767

§ 371 Date: Jul. 24, 2025

Related U.S. Application Data
(60) Provisional application No. 63/440,947, filed on Jan. 25, 2023.

(51) Int. Cl. C04B 28/18; C04B 11/00; C04B 11/06; C04B 11/26; C04B 14/04; C04B 14/06; C04B 14/10; C04B 28/14; C04B 28/16; C04B 103/00

(52) U.S. Cl. CPC C04B 28/188; C04B 11/005; C04B 11/06; C04B 11/266; C04B 14/041; C04B 14/06; C04B 14/108; C04B 28/141; C04B 28/16; C04B 2103/0014; C04B 2235/3208; C04B 2235/3454

(57) ABSTRACT

Methods for making a cement clinker include providing a source of calcium oxide, and wherein the source of calcium oxide has at least one of calcium sulfate and calcium sulfite; and heating the source of calcium oxide to decompose the source of calcium oxide, wherein the heating includes generating heat by using a low-carbon or carbon-free fuel.

### REFERENCE TO RELATED APPLICATIONS

This application claims the benefit of priority pursuant to 35 U.S.C. § 119 (e) to U.S. provisional Application No. 63/440,947 filed Jan. 25, 2023, the entire contents of which are incorporated by reference as if fully set forth herein.

### FIELD AND BACKGROUND OF THE INVENTION

The present application is directed to the production of cement using techniques that result in substantial reductions in carbon dioxide emissions.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions, or is known to be relevant to an attempt to solve any problem with which this specification is concerned.

The production of conventional hydraulic cement, such as ordinary Portland cement (OPC), is a very energy-intensive process and a major contributor to greenhouse gas emissions, introducing about fifty-two billion tons of greenhouse gases into the atmosphere every year. Cement production is responsible for 7-8% of global CO₂ emissions due to its high-volume production, which is about 4 billion tons annually, as well as the nature of conventional cement raw materials and processes of making the cement therefrom.

Conventionally, when a ton of cement clinker is made, 0.8 to 1.2 tons of CO₂ gas is emitted depending on the efficiency of the kiln. Cement is made by heating limestone (CaCO₃) and other raw material such as shale (e.g., Al₂Si₂O₅ (OH)₄) to high temperatures, about 1450° C., in rotary kilns. Upon heating, limestone decomposes at around 900° C. to form lime and CO₂ gas. Lime then reacts with silica, alumina and iron oxide present in the raw material mix at elevated temperatures to form the major phases, alite, belite, tricalcium aluminate and tetracalcium aluminoferrite. The particles fuse together at high temperatures and come out of the kiln as big chunks of solid material called clinkers while CO₂ gas is emitted into the atmosphere. In the most fuel-efficient modern cement plants, two thirds of the CO₂emission come from the decomposition of limestone, and the remaining one third of the emissions come from the combustion of the fuel used to fire the kiln and/or other equipment.

Cement plants are built on limestone quarries because lime is the primary ingredient in cement making. To make one ton of cement clinker, 600-650 kg of CaO is needed, and this corresponds to 1.1-1.2 tons of limestone resulting in 490 to 530 kg of CO₂ emissions excluding the fuel emissions. The lifetime of the quarries ranges from 20-50 years with an annual cement production of 1-1.5 million tons. Cement companies are under a lot of pressure to reduce/eliminate their CO₂ emissions by 2050.

There are currently four major strategies for reducing CO₂ emissions:
Clinker factor reduction;
Re-carbonation;
Alternative fuels with low/no CO₂ footprint; and
Carbon capture and sequestration.

Each proposed solution has its own challenges and have limited effects on reducing carbon dioxide emissions. Each of these conventional approaches are summarized as follows.

Clinker factor reduction involves replacing a portion of the conventional cement with supplemental cementitious materials (“SCM”) such as fly ash, slag, limestone, natural or synthetic pozzolans, calcined clays, etc. The maximum average potential CO₂ savings are about 30%. A major challenge is degradation of the quality of the product if these supplementary materials are added in large amounts, as well as their availability and cost.

The alternative fuels approach concerns replacing fuels used for firing the kilns and other equipment, such as coal, with low-carbon footprint fuels. In the most extreme case, when coal is replaced with hydrogen gas, the maximum CO₂ savings will be about 33% because fuel combustion is only responsible for one-third of the CO₂ emissions in cement making when limestone is used as a raw material.

Carbon capture involves capturing the CO₂ from the kiln flue gas stream, cleaning it, compressing and injecting it underground. This method is limited to the accessibility of underground storage, which most cement plants may not have access to. Another challenge is the cost and energy requirements of CO₂ separation and compression.

These previously proposed solutions briefly discussed above typically include the use limestone (CaCO₃) as the CaO source. As noted, limestone is responsible for two thirds of the CO₂ emissions in cement making. Replacing limestone with a different Ca mineral that does not contain carbon has the potential to reduce CO₂ emissions significantly.

Gypsum (CaSO₄·2H₂O), calcium sulfate hemihydrate (e.g., CaSO₄·0.5H₂O), and calcium sulfate anhydride (e.g., CaSO₄), which are various forms of calcium sulfate, is the second most abundant Ca source after limestone. As a comparison, in 2019, cement production was 87 million tons in the US, produced in 96 plants in 34 states, whereas gypsum consumption was 41 million tons in the US, produced in 52 mines in 16 states. CaSO₄ does not contain any carbon in its structure and upon decomposition to CaO, it does not emit CO₂. The basic decomposition reaction is: CaSO₄ (s)=CaO(s)+SO₂ (g)+0.502 (g).

The thermal decomposition of calcium sulfate was studied in 1900's to use calcium sulfate as a sulfur source to make sulfuric acid, and to solve the handling problem of the partially sulfated lime material in power generation plants. There are various ways of decomposing CaSO₄ into CaO. To enhance the decomposition rates, usually a reducing atmosphere such as CO, CH₄, or H₂, is preferred. The chemical reactions for various reducing atmospheres are shown below.

In the presence of carbon monoxide:

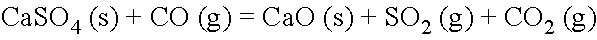

In the presence of methane:

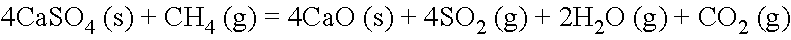

In the presence of hydrogen gas:

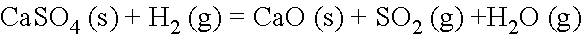

As can be seen from the equations, different reducing atmospheres will result in significantly different CO₂ emissions per amount of lime produced. For example, in a carbon monoxide atmosphere, 1 mole of CO₂ will be emitted per mole of CaO produced. In the case of methane, only 1 mole of CO₂ will be emitted for 4 moles of CaO produced. In the case of hydrogen gas, there are no CO₂ emissions.

There are also other ways of enhancing decomposition rates without emitting CO₂, such as using nitrogen, steam, silicates etc.

Once CaO is formed, it can be used as an intermediate compound to react with silica, alumina and iron oxide present in the raw materials at elevated temperatures to synthesize hydraulic cement. In the early 1900's sulfuric acid was synthesized from calcium sulfate, and cement clinker was formed as a by-product. The plants were shut down when the sulfur crises ended because the process was not economical when compared to the process of using elemental sulfur. The quality of the cement clinker was low due to difficulties in controlling the reducing environment in the kiln, and the major focus was on producing sulfuric acid. Often, the by-product clinker was discarded totally or a minor fraction of it was blended with high quality clinker made from limestone. Coal was used as the fuel to provide necessary heat and the reducing atmosphere of carbon monoxide for the process. Coal has a high carbon footprint compared to other fuels such as hydrocarbons. The decomposition of calcium sulfate requires more energy, almost double, when compared to decomposition of limestone and when high carbon footprint fuels such as coal are used in this process, and thus will not provide any major CO₂ reduction.

There have been efforts in reducing the CO₂ emissions during cement making from limestone by using alternative fuels. In the most extreme case, hydrogen gas can be used as a fuel. However, even in this case, the CO₂ savings are limited to around 33% at the most, because fuel combustion is only responsible for one-third of the CO₂ emissions during cement production when limestone is used as a raw material.

Thus, there remains a need for improved cement production that further reduces CO₂ emissions or eliminates them, thus reducing the global effect of climate change. The present disclosure addresses these problems.

While certain aspects of conventional technologies have been discussed to facilitate disclosure of the invention, Applicant in no way disclaims these technical aspects, and it is contemplated that the claimed invention may encompass or include one or more of the conventional technical aspects discussed herein.

### SUMMARY OF THE INVENTION

It has been discovered that the above-noted deficiencies can be addressed, and certain advantages attained, by the present invention. For example, the methods and compositions of the present invention replace limestone with calcium sources that do not contain carbon, such as any form of calcium sulfate and/or sulfite, and use low-carbon fuels for generating the heat needed to decompose and react the raw materials and form cement clinker. According to the principles of the present invention, the building and construction industry could be transformed from one of the major CO₂ emitters to the world's largest CO₂ sink. It is technically possible to convert calcium sulfate/sulfite into calcium oxide, and transform the thus formed calcium oxide to cement, without emitting any CO₂ by using calcium sources that do not contain carbon and carbon-free fuels, such as green hydrogen. Furthermore, the cured cement can react with and absorb carbon dioxide from the environment. The byproducts of this process will support the overall global economy by providing additional sulfuric acid, an essential industrial chemical which has a broad range of applications ranging from batteries to fertilizers.

Exemplary embodiments are directed to a method of making a cement clinker, the method comprising: providing a source of calcium oxide, and wherein the source of calcium oxide comprises at least one of calcium sulfate and calcium sulfite; and heating the source of calcium oxide to decompose the source of calcium oxide, wherein the heating comprises generating heat by using a low-carbon or carbon-free fuel.

In the methods described above, the decomposition of the source of calcium oxide can be performed in a stochiometric or reducing environment containing the low-carbon or carbon-free fuel.

In the methods described above, the decomposition of the source of calcium oxide can be performed in alternating stoichiometric/reducing and oxidizing atmospheres.

In the methods described above, the calcium sulfate may comprise CaSO₄·XH₂O, where X is 0, 0.5, or 2; and the calcium sulfite may comprise CaSO₃·XH₂O, where X is 0.5, or 4.

In the methods described above, the calcium oxide source can comprise at least one of calcium sulfate anhydride, calcium sulfate hemi-hydrate, gypsum, calcium sulfite hemihydrate or calcium sulfite tetrahydrate, individually or in combination.

In the methods described above, the methods can further comprise forming a mixture of raw materials comprising the CaO source, the raw materials can further comprise one or more sources of at least one of: aluminum, silicon, or iron, or combinations thereof.

In the methods described above, the one or more sources of at least one of: aluminum, silicon, or iron, or combinations thereof do not contain carbon.

In the methods described above, the one or more sources of at least one of: aluminum, silicon, or iron, or combinations thereof comprise: shale (Al₂Si₂O₅ (OH)₄), clay, slate, or silica sand, and combinations thereof.

In the methods described above, the fuel comprises a low-carbon fuel, and the low-carbon fuel can comprise natural gas, propane, butane, alcohols, biological waste, oils, waste oil, plastics, or used car tires.

In the methods described above, the fuel can comprise a carbon-free fuel, and the carbon-free fuel can comprise hydrogen gas.

In the methods described above, the heating to decompose the source of calcium oxide can comprise heating the source of calcium oxide to a temperature of about 1,000° C. or more.

In the methods described above, the method may further comprise forming a mixture of raw materials comprising the source of calcium oxide, the raw materials may further comprise one or more sources of at least one of: aluminum, silicon, or iron, or combinations thereof, and the heating may further comprise heating the raw materials to react the CaO formed as a result of the decomposition reaction with the one or more sources of at least one of: aluminum, silicon, or iron, or combinations thereof, to form one or more phases of alite, belite, tricalcium aluminate and tetracalcium aluminoferrite.

In the methods described above, the one or more sources of at least one of: aluminum, silicon, or iron, or combinations thereof can comprise: shale (Al₂Si₂O₅ (OH)₄), clay, slate, or silica sand, and combinations thereof.

In the methods described above, the heating can be performed in a rotary kiln.

In the methods described above, further comprising: forming a mixture of raw materials, the mixture comprising the source of calcium oxide; and heating the mixture of raw materials to decompose the source of calcium oxide and/or calcine the raw materials to form the cement clinker.

In the methods described above, the heating may further comprise one or more of the following steps: pre-heating the source of calcium oxide in a suspended state; pre-calcining the source of calcium oxide to a degree sufficient to decompose at least 50% of the pre-heated source of calcium oxide; and calcining the raw materials to decompose the remainder of the CaO source and/or calcine the raw materials through completion.

In the methods described above, the source of calcium oxide can be pre-calcined separately from the raw materials, then subsequently combined with the raw materials, and calcined.

In the methods described above, the heating may further comprise cooling the cement clinker.

In the methods described above, the method can further comprise capturing SOₓ gas released during the decomposition.

In the methods described above, the captured SOₓ gas can be converted into SO₃ gas.

In the methods described above, the SO₃ gas can be converted into sulfuric acid.

In the methods described above, heat generated during at least one of the converting the captured SOₓ gas into SO₃ gas and converting the SO₃ gas into sulfuric acid can be recovered and used to heat the raw materials.

In the methods described above, heat generated during at least one of the converting the captured SOₓ gas into SO₃ gas and converting the SO₃ gas into sulfuric acid can be recovered and used to heat households.

In the methods described above, the cement clinker can be formed with at least about 30% less carbon dioxide emissions relative to CO₂ emissions produced by cement making processes that utilize carbon-containing raw materials as a source for CaO, and/or fuels other than low-carbon or carbon-free fuels.

In the methods described above, the cement clinker can be formed with CO₂ emissions of about 570 kg of CO₂ or less per ton of cement clinker.

### DETAILED DESCRIPTION

Further aspects, features and advantages of this invention will become apparent from the detailed description which follows. It should be understood that the various individual aspects and features of the present invention described herein can be combined with any one or more individual aspect or feature, in any number, to form embodiments of the present invention that are specifically contemplated and encompassed by the present invention. Furthermore, any of the features recited in the claims can be combined with any of the other features recited in the claims, in any number or in any combination thereof. Such combinations are also expressly contemplated as being encompassed by the present invention.

As used herein, the singular forms “a”, “an” and “the” are intended to include the plural forms as well, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the endpoints of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the “inclusive” sense of “and/or” and not the “exclusive” sense of “either/or.”

Unless indicated otherwise, each of the individual features or embodiments of the present specification are combinable with any other individual feature or embodiment that are described herein, without limitation. Such combinations are specifically contemplated as being within the scope of the present invention, regardless of whether they are explicitly described as a combination herein.

Technical and scientific terms used herein have the meaning commonly understood by one of skill in the art to which the present description pertains, unless otherwise defined. Reference is made herein to various methodologies and materials known to those of skill in the art.

### Raw Materials Providing Calcium

Calcium oxide (CaO), lime, is the major ingredient in cement making. In this invention, the source of lime comprises a compound of calcium oxide and SOx where x can be 2 or 3. When x is 3, the compound is calcium sulfate, CaSO₄, and when x is 2, the compound is calcium sulfite, CaSO₃. According to certain embodiments, the source of lime may consist of a compound of calcium oxide and SOx, where x is 2 or 3, or the source of lime may consist essentially of a compound of calcium oxide and SOx, where x is 2 or 3.

Calcium sulfate can have various forms depending on the amount of crystalline water in the compound, and is written as CaSO₄·XH₂O, where X can be 0, 0.5, or 2. In the case of calcium sulfite, CaSO₃·XH₂O, X can be 0.5, or 4. Calcium sulfate has various forms in nature. Anhydrite (X=0), hemi-hydrate (X=0.5) and gypsum (X=2). Calcium sulfate and/or calcium sulfite can also be synthetic. They can also be recycled. They can also be a byproduct of an existing process, or they can be a waste material. They can be crystalline or amorphous.

According to the principles of the present invention, it is contemplated that the CaO source can comprise at least one of: calcium sulfate anhydride, calcium sulfate hemi-hydrate, gypsum, calcium sulfite hemihydrate or calcium sulfite tetrahydrate, individually or in any combination with each other. According to certain optional aspects, the CaO source can consist of, or consist essentially of, at least one of: calcium sulfate anhydride, calcium sulfate hemi-hydrate, gypsum, calcium sulfite hemihydrate or calcium sulfite tetrahydrate, individually or in any combination with each other.

The raw materials may further include one or more sources of at least one of: aluminum, silicon, or iron, or combinations thereof. According to certain embodiments, these materials do not contain carbon. According to nonlimiting examples, these source materials may comprise: shale (e.g., Al₂Si₂O₅(OH)₄), clay, slate, and/or silica sand, and combinations thereof.

### Fuels

As used herein, the term “low-carbon fuels” are fuels that contain combustible elements in addition to carbon, including but not limited to natural gas, propane, butane, alcohols, biological waste, oils, waste oil, plastics, and used car tires, etc.

As used herein, the term “carbon-free fuels” are fuels that do not contain any carbon, including but not limited to hydrogen gas, preferably green hydrogen gas (hydrogen gas that is produced without any CO₂ emissions), thus providing a 100% decrease in CO₂ emissions.

According to certain alternative embodiments, the equipment used to heat the raw materials is powered by electricity, preferably by electricity generated using renewable resources.

When calcium sulfate or calcium sulfite is heated, it first loses crystalline water, if there is any. For example, if gypsum is used, it will transform into hemihydrate upon heating, and then it will transform into anhydrite. As the temperature increases, CaSO₄ will decompose into CaO, SO₂ gas, and oxygen gas. The equilibrium partial pressure of this decomposition reaction is very low, and it will reach equilibrium very quickly and the decomposition will stop. To push the reaction forward, at least one reaction product should be consumed. When a reducing environment is provided during decomposition of the Ca source, oxygen gas released during decomposition will be consumed, and the reaction will no longer be in equilibrium and the decomposition reaction will continue to proceed. Once calcium oxide is formed, it is then used to form cement by reacting it with silica, alumina and iron oxide present in the raw material mix at elevated temperatures of up to about 1,450° C. to form the phases present in cement clinker. When this process is carried out by using low-carbon fuels, or fuels without any carbon, significant CO₂ emissions reduction, of roughly 30% or more is achievable, when compared with the amount of CO₂ emissions when this process is performed using conventional carbon-based fuels.

### Exemplary Methods

Through implementing the methods described herein and those contemplated by the present invention, CO₂ emissions from the manufacture of cement clinker can be greatly reduced relative to CO₂ emissions produced by conventional cement making processes that utilize carbon-containing raw materials as a source for CaO, and/or fuels other than low-carbon or carbon-free fuels. According to further aspects, CO₂ emissions are reduced by the methods of the present invention by at least about 30%, at least about 50%, at least about 60%, at least about 80%, about 30%-about 100%, about 30%-about 80%, about 30%-about 60%, or about 30%-about 50%, about 50%-about 100%, about 50%-about 80%, or about 50%-about 60%, relative to CO₂ emissions produced by conventional cement making processes that utilize carbon-containing raw materials as a source for CaO, and/or fuels other than low-carbon or carbon-free fuels. According to further alternative embodiments, the methods of the present invention provide a route for producing cement clinker with carbon dioxide emissions of about 570 kg of CO₂ or less/ton of clinker. In other words, the methods of the present invention produce cement clinker with 0-about 570 kg CO₂/ton of clinker.

Generally, the methods of making a cement clinker according to the principles of the present invention includes: providing a source of calcium oxide, and wherein the source of calcium oxide comprises at least one of calcium sulfate and calcium sulfite; and heating the source of calcium oxide to decompose the source of calcium oxide, wherein the heating comprises generating heat by using a low-carbon or carbon-free fuel, as also described above.

As further noted above, the raw materials may further include one or more sources of at least one of: aluminum, silicon, or iron, or combinations thereof. When included, the heating process is further performed to an extent necessary to react the CaO formed as a result of the decomposition reaction, with the one or more sources of at least one of: aluminum, silicon, or iron, or combinations thereof, thereby forming cement clinker. This is often referred to as calcination. More specifically, this may involve reacting calcium oxide with silica, alumina and/or iron oxide present in the raw material mix at elevated temperatures to form phases such as alite, belite, tricalcium aluminate and tetracalcium aluminoferrite.

The CaO source is heated to a temperature necessary to decompose the source of calcium oxide. The temperature needed for doing so will vary depending upon a number of different factors. According to exemplary and non-limiting examples, heating to temperatures of greater than about 1,000° C. will be sufficient to cause decomposition of the source of calcium oxide, as well as the calcination of any additional raw materials. According to certain embodiments, the heating is performed at temperatures of about 1,000° C. to about 1,300° C. Further, according to certain exemplary embodiments, the heating can be performed for any suitable time necessary to accomplish both decomposition of the CaO source as well as calcination of the raw materials. An exemplary and nonlimiting timeframe for doing so would be about 3 seconds to about 3 hours.

The raw materials can be combined with each other using any suitable technique. According to one exemplary technique, the rocks and minerals are ground together thus forming a mixture. This mixture can then be subjected to the heating process described herein.

Alternatively, the CaO source the can be processed and heated separately to the point of at least partial decomposition. The partially (or fully) decomposed CaO source can then be combined with the additional raw materials, using any suitable technique, then calcined. One such technique for combining them is a conventional hot-mixing step. Heating the source of calcium oxide to the point of at least partial decomposition may prove advantageous in that it reduces or prevents the formation of intermediate reaction products or phases that can occur when the entire mixture of raw materials is heated together.

To enhance the decomposition rates, decomposition is preferably performed in either a stochiometric or reducing atmosphere. The presence of excess oxygen during the decomposition reaction will prematurely stop decomposition. On the other hand, if a strong reducing atmosphere is used, the formation of a CaS phase may result. Thus, according to one optional embodiment, the decomposition reaction is performed in a stoichiometric atmosphere. According to certain optional embodiments, in order to provide a favorable atmosphere for driving the decomposition reaction, decomposition is conducted in an environment that contains the low-carbon fuel or the carbon-free fuel, such as one or more of CH₄, and H₂. According to further optional aspects, the decomposition is conducted in an environment that consists of, or consists essentially of, the low-carbon fuel and/or the carbon-free fuel. Different reducing atmospheres will result in significantly different CO₂ emissions per amount of lime (CaO) produced. For example, in the case of methane, only 1 mole of CO₂ will be emitted for 4 moles of CaO produced. In the case of hydrogen gas, there are no CO₂ emissions.

According to certain alternative embodiments, decomposition is performed in an atmosphere that cycles between stochiometric or reducing atmosphere(s) and an oxidizing atmosphere(s). The different atmospheres can be cycled any suitable number of times, but comprises at least one stochiometric or reducing atmosphere and at least one oxidizing atmosphere. The different atmospheres can be cycled using any suitable technique. For example, the heating equipment (e.g., reactor, rotary kiln, pre-calciner, etc.) can be provided with a plurality of reaction zones, with each zone having either a stochiometric/reducing atmosphere or an oxidizing atmosphere. The material being heated is moved through the different reaction zones during the heating procedure. Heating in alternating stochiometric or reducing atmosphere(s) and an oxidizing atmosphere(s) can provide an advantage in that the formation of undesirable phases, such as the CaS phase noted above, can be mitigated or avoided completely.

In one embodiment, calcium sulfate is mixed with shale (e.g., Al₂Si₂O₅(OH)₄) and heated in the presence of natural gas in a rotary kiln. The rotary kiln can be modified so that it can be fueled with natural gas instead of coal. Natural gas reacts with released oxygen and pushes decomposition reaction for calcium sulfate to completion while the formed CaO reacts with silica, alumina, and iron oxide in the raw materials mixture to form alite, belite, tricalcium aluminate and tetracalcium aluminoferrite phases at temperatures up to, for example, about 1,450° C., for about 3 second to about 3 hours. This process providing at least about 30% CO₂ emissions reduction relative to CO₂ emissions produced by conventional cement making processes that utilize carbon-containing raw materials as a source for CaO, and/or fuels other than low-carbon or carbon-free fuels. According to further aspects, CO₂ emissions are reduced by at least about 50%, or at least about 60%.

In another embodiment, calcium sulfate is mixed with shale and heated in the presence of hydrogen gas in a rotary kiln. The rotary kiln is modified so that it can be fueled with hydrogen gas, preferably green hydrogen gas, instead of coal. Hydrogen gas reacts with released oxygen and pushes the decomposition reaction for calcium sulfate of to completion while the formed CaO reacts with silica, alumina, and iron oxide to form alite, belite, tricalcium aluminate and tetracalcium aluminoferrite phases at temperatures up to, for example, 1,450° C., for about 3 second to about 3 hours, providing full elimination of CO₂ emissions.

According to further alternative embodiments, additional pyro-processing equipment can be utilized in the decomposition and reaction of the raw materials. According to one nonlimiting example, the major components of the pyro-processing equipment may include: cyclones, calciners, high temperature mixers, reaction chambers, kilns, coolers, etc. The size, number and configuration of each component can be tailored according to the specific process requirements.

According to one specific and nonlimiting example, the pyro-process uses one or more of the following types of equipment: 1) cyclones, in which the raw materials, including a calcium oxide source are pre-heated with hot gases coming off the kiln in a suspended state; 2) a pre-calciner, in which at least about 50% of the pre-heated calcium source is decomposed; 3) a rotary kiln, in which the raw materials are heated to decompose the remainder of the CaO source and/or calcine the pre-calcined raw material through completion to react CaO with other components to form cement clinker (e.g., ordinary Portland cement clinker); and 4) a cooler, in which the clinker emerging from the line is cooled with air to stabilize the alite phase and the hot air is removed for cooling is optionally sent to the pre-calciner. According to the principles of the present invention, low-carbon or carbon-free fuels can be used to power any or all of these pieces of equipment. According to further alternative embodiments, the CaO source is initially separate from the remaining raw materials, and is pre-calcined separately. The CaO source is his pre-calcined to any suitable degree, such as at least about 50%. Subsequent to separately pre-calcining the CaO source, it is then introduced into the remaining raw materials for the remainder of the heating process.

In another embodiment, SOₓ gas released upon decomposition of CaSO₄ is captured and converted into SO₃ gas. SO₃ gas is then converted into sulfuric acid. Any conventional process can be used for converting the SOₓ gas into sulfuric acid. Such processes include, but are not limited to, a contact process and a wet sulfuric acid process. Heat generated during SOₓ to SO₃ gas conversion and/or converting the SO₃ gas into sulfuric acid is recovered and used in the heating process of to further reduce CO₂ emissions by reducing the amount of fuel needed to heat the raw materials.

In another embodiment, heat generated during SOₓ to SO₃ gas conversion and/or converting the SO₃ gas into sulfuric acid is recovered and used for heating households in the community. Production of a ton of sulfuric acid (corresponds to a ton of clinker production) and produces 2.04 gigajoules of low-grade heat is produced (55%): 2.04 Gigajoules=566 kilowatt hours (1 gigajoule=278 kwh).

With a million-ton yearly capacity cement manufacturing/sulfuric acid producing facility, the heat adds up to 566,000,000 kwh. A typical 1,000 square feet household requires around 10,000 kwh of energy annually for heating in an area such as New Jersey. For a larger household of 3,000 square feet, the requirement will be around 30,000 kwh. So, with the energy created out of a million-ton capacity cement manufacturing/sulfuric acid producing facility, heating can be provided for 18,800 to 56,600 households varying between 1,000 to 3,000 square feet.

When creating 1 kwh of electricity using coal, 1.82 pounds (820 grams) of CO₂ is emitted. The CO₂ emissions combusting natural gas to produce 1 kwh electricity is around 1.1 pounds (490 grams). The average emission per 1 kwh production is as follows considering the percentage of electricity produced using coal and natural gas in US (ignoring the 2% production with other resources for simplicity): 1.82×55%+1.1×45%=1.5 pounds.

Thus, the 566 million kwh of energy utilized for heating purposes reduces the yearly CO₂ emission of US by around 849 million pounds. According to further embodiments, heat generated during SOₓ to SO₃ gas conversion and/or converting the SO₃ gas into sulfuric acid is recovered and used for algae production or to heat greenhouses.

In another embodiment, SO₃ gas is separated from the gas stream and compressed for commercial use.

In one embodiment, the calcium source comprises an anhydrite and the fuel comprises natural gas.

In another embodiment, the calcium source comprises a hemihydrate, and the fuel comprises natural gas.

In another embodiment, the calcium source comprises anhydrite and the fuel comprises hydrogen gas.

In another embodiment, the calcium source comprises hemihydrate, and the fuel comprises hydrogen gas.

In another embodiment, the calcium source comprises gypsum and the fuel comprises hydrogen gas.

In another embodiment, the cement clinker produced as set forth herein is ground and mixed with gypsum to produce ordinary Portland cement.

### Example

According to one specific and nonlimiting example contemplated by the present invention, for one ton of OPC clinker, 1.6 tons of sodium sulfate anhydrite or 2 tons of gypsum will be needed as a CaSO₄ raw material and 330 kg of shale will be needed as an Al/Si source. To provide the necessary energy to produce one ton of OPC clinker, 138 kg of natural gas will be consumed if gypsum is used as the raw material. The amount of natural gas can drop down to 52 kg if heat recovery is included and anhydrite is used as a raw material. It is estimated that 25 kg of hydrogen will be needed for the same work. The energy requirement will vary from 2.9 to 7.7 GJ per ton of OPC clinker depending on the raw material and on the degree of heat recovery. In the worst-case scenario, where there is no heat recovery and gypsum is used as a raw material, the expected CO₂ savings is about 54% vs. traditional OPC production (380 vs 834 kg of CO₂ emission/ton of clinker). In the best-case scenario, where heat is recovered fully and sodium sulfate anhydrite is used as a raw material, the expected CO₂ savings will be about 83% (143 vs 834 kg of CO₂ emission/ton of clinker). If hydrogen is used instead of natural gas, CO₂ emissions could be 100% eliminated.

As various changes could be made in the above methods and compositions without departing from the scope of the invention, it is intended that all matter contained in the above description shall be interpreted as illustrative and not in a limiting sense. Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

1. A method of making a cement clinker, the method comprising:
providing a source of calcium oxide, and wherein the source of calcium oxide comprises at least one of calcium sulfate and calcium sulfite;
heating the source of calcium oxide to decompose the source of calcium oxide, wherein the heating comprises generating heat by using a low-carbon or carbon-free fuel.

2. The method of claim 1, wherein the decomposition of the source of calcium oxide is performed in a stochiometric or reducing environment containing the low-carbon or carbon-free fuel.

3. The method of claim 1, wherein the decomposition of the source of calcium oxide is performed in alternating stoichiometric/reducing and oxidizing atmospheres.

4. The method of claim 1, wherein the calcium sulfate comprises CaSCL-XffcO, where X is 0, 0.5, or 2; and the calcium sulfite comprises CaSCh-XthO, where X is 0.5, or 4.

5. The method of claim 1, wherein the calcium oxide source comprises at least one of calcium sulfate anhydride, calcium sulfate hemi-hydrate, gypsum, calcium sulfite hemihydrate or calcium sulfite tetrahydrate, individually or in combination.

6. The method of claim 1, wherein the method further comprises forming a mixture of raw materials comprising the CaO source, the raw materials further comprise one or more sources of at least one of: aluminum, silicon, or iron, and combinations thereof.

7. The method of claim 6, wherein the one or more sources of at least one of aluminum, silicon, or iron, or combinations thereof do not contain carbon.

8. The method of claim 6, wherein the one or more sources of at least one of aluminum, silicon, or iron, or combinations thereof comprise: shale (Al₂Si₂O₅(OH)₄), clay, slate, or silica sand, and combinations thereof.

9. The method of claim 1, wherein the fuel comprises a low-carbon fuel, and the low-carbon fuel comprises natural gas, propane, butane, alcohols, biological waste, oils, waste oil, plastics, or used car tires, and combinations thereof.

10. The method of claim 1, wherein the fuel comprises a carbon-free fuel, and the carbon-free fuel comprises hydrogen gas.

11. The method of claim 1, wherein the heating to decompose the source of calcium oxide comprises heating the source of calcium oxide to a temperature of about 1,000° C. or more.

12. The method of claim 1, the method further comprising:
forming a mixture of raw materials comprising the source of calcium oxide, the raw materials further comprise one or more sources of at least one of: aluminum, silicon, or iron, and combinations thereof, and
the heating further comprises heating the raw materials to react CaO formed as a result of the decomposition reaction with the one or more sources of at least one of aluminum, silicon, or iron, and combinations thereof to form one or more phases of alite, belite, tricalcium aluminate and tetracalcium aluminoferrite.

13. The method of claim 1, wherein the one or more sources of at least one of aluminum, silicon, or iron, and combinations thereof comprise: shale (AhSi2O5(OH)4), clay, slate, or silica sand, and combinations thereof.

14. The method of any of claim 1, wherein the heating is performed in a rotary kiln.

15. The method of claim 1, further comprising:
forming a mixture of raw materials, the mixture comprising the source of calcium oxide; and
heating the mixture of raw materials to decompose the source of calcium oxide and/or calcine the raw materials to form the cement clinker.

16. The method of claim 1, wherein the heating further comprises one or more of the following steps:
pre-heating the source of calcium oxide in a suspended state;
pre-calcining the source of calcium oxide to a degree sufficient to decompose at least 50% of the pre-heated source of calcium oxide; and
calcining the raw materials to decompose the remainder of the CaO source and/or calcine the raw materials through completion.

17. The method of claim 16, wherein the source of calcium oxide is pre-calcined separately from the raw materials, then subsequently combined with the raw materials, and calcined.

18. The method of claim 1, wherein the heating further comprises cooling the cement clinker.

19. The method of claim 1, wherein the method further comprises capturing SO_{X} gas released during the decomposition.

20. The method of claim 19, further comprising converting the captured SO_{X} gas into SO₃ gas.

21. The method of claim 20, further comprising converting the SO₃ gas into sulfuric acid.

22. The method of claim 20, wherein heat generated during at least one of the converting the captured SO_{X} gas into SO₃ gas and converting the SO₃ gas into sulfuric acid is recovered and used to heat the raw materials.

23. The method of claim 20, wherein heat generated during at least one of the converting the captured SO_{X} gas into SO₃ gas and converting the SO₃ gas into sulfuric acid can be recovered and used to heat households.

24. The method of claim 1, wherein the cement clinker is formed with at least about 30% less carbon dioxide emissions relative to CO₂ emissions produced by cement making processes that utilize carbon-containing raw materials as a source for CaO, and/or fuels other than low-carbon or carbon-free fuels.

25. The method of claim 1, wherein the cement clinker is formed with CO₂ emissions of about 570 kg of CO₂ or less per ton of cement clinker.
